(19) United States
(12) Patent Application Publication
(10) Pub. No.: US 2008/0182498 A1
(43) Pub. Date: Jul. 31, 2008

(54) HEATING, VENTILATION, AND COOLING CASE AND DUCT HAVING PASSIVE NOISE REDUCTION

(76) Inventor: Dhanunjay Vejalla, Novi, MI (US)

Correspondence Address: VISTEON, C/O BRINKS HOFER GILSON & LIONE, PO BOX 10395, CHICAGO, IL, 60610, US

(21) Appl. No.: 11/668,925

(22) Filed: Jan. 30, 2007

(51) Int. Cl. B60H 1/00

(52) U.S. Cl. 454/75

(57) ABSTRACT

A heating, ventilation, and air conditioning (HVAC) case and duct for passively reducing noise, vibration and harshness (NVH) during operation of the HVAC system. The duct includes an outer wall defining a inner chamber opening into, for example, a passenger compartment of a motor vehicle. Interior walls define at least first and second air passages. A first air stream flows through the first air passage to the ventilation port. The second air passage intersects the first air passage upstream of the ventilation port at an output aperture. The second air stream may flow into the first air passage through the output aperture including a slotted wall to reduce NVH.

### BACKGROUND

1. Field of the Invention

The present invention generally relates to heating, ventilation, and air conditioning (HVAC) systems. More specifically, the invention relates to a duct for use in a motor vehicle HVAC system having passive noise reduction.

2. Description of Related Art

In existing HVAC systems, ducts are used to direct air to desired locations. The ducts often contain various elements that can be a significant source of noise, vibration and harshness (NVH) when the HVAC system is in operation. The noise is particularly evident where two air streams mix within the ducts. For example, hot air downstream of a heater core generally has higher pressure than cool air downstream of, for example, a condenser. Therefore, when a hot air stream and a cold air stream mix, there can be a significant pressure drop causing NVH. In addition, where an air stream changes direction there can be significant turbulence in the flow also contributing to the overall NVH.

In view of the above, it is apparent that there exists a need for an improved HVAC system having an improved duct capable of reducing NVH.

### SUMMARY

In satisfying the above need, as well as overcoming the enumerated drawbacks and other limitations of the related art, the present invention provides a case and duct assembly for an HVAC system having reduced NVH characteristics. The duct assembly includes an outer wall defining a interior volume and including at least one ventilation port. Interior walls define at least two air passages. The first air passage has an input portion extending to the ventilation port such that a first air stream may flow from the input portion through the ventilation port. The second air passage has an input section extending to an output aperture intersecting the first air passage such that a second air stream may flow from the input section into the first air passage. A mixing zone is formed in the first air passage adjacent the output aperture where the first air stream mixes with the second air stream. Arranged across the output aperture is a slotted wall.

In some embodiments, the first air passage includes a pivotable first air blend door upstream of the mixing zone. The first air blend door may pivot to any position between a fully open and a fully closed position to regulate airflow from the first air input portion into the mixing zone, thereby controlling a final temperature of the mixed air. Other embodiments may substitute or add an additional pivotable second air blend door upstream of the output aperture. The second air blend door may pivot to any position between a fully open and a fully closed position to regulate airflow from the second air input section into the mixing zone to provide an alternate means of controlling the final temperature of the mixed air.

According to another aspect of the present invention, the duct assembly includes at least one additional passage, wherein an upstream segment of the additional passage intersects the first air passage between the ventilation port and the mixing zone. In one example, an optional mixed air blend door is disposed between the ventilation port and the mixing zone. The mixed air blend door may pivot between two orientations where one prevents airflow from entering the additional passage and the other prevents airflow from exiting through the ventilation port and directs the airflow entirely into the additional passage. Additionally, the mixed air blend door may pivot to any position between these orientations to control the amount of airflow directed through the ventilation port and into the additional passage.

In yet another embodiment, the slots in the slotted wall are narrow slots having a length substantially greater than their width. In other examples, the narrow slots may have any appropriate orientation including, for example, substantially parallel, perpendicular or at an acute angle to a direction of the first air stream.

Another aspect of the present invention includes an HVAC system having passive noise reduction for use in a motor vehicle. The system includes any of the duct assemblies described above wherein the ventilation port is arranged to ultimately open into a passenger compartment of the motor vehicle. This embodiment also includes at least one blower fluidly coupled to the duct assembly and providing airflow therein. The airflow is divided into the first air stream and the second air stream. An evaporator is disposed in the first air stream thereby cooling the first air stream and a heater core is disposed in the second air stream thereby heating the second air stream such that the resulting mixed air has a mixed or blended air temperature.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a sectional view of a portion of a duct assembly including a slotted wall according to the present invention;

FIG. 2A is a sectional view of the duct assembly, generally taken along line 2-2 in FIG. 1, showing a first embodiment of the slotted wall;

FIG. 2B is a second embodiment of the slotted wall;

FIG. 2C is a third embodiment of the slotted wall;

FIG. 2D is a fourth embodiment of the slotted wall; and

FIG. 3 is a sectional view of a heating, ventilation, and air conditioning system including the duct assembly of FIG. 1.

### DETAILED DESCRIPTION

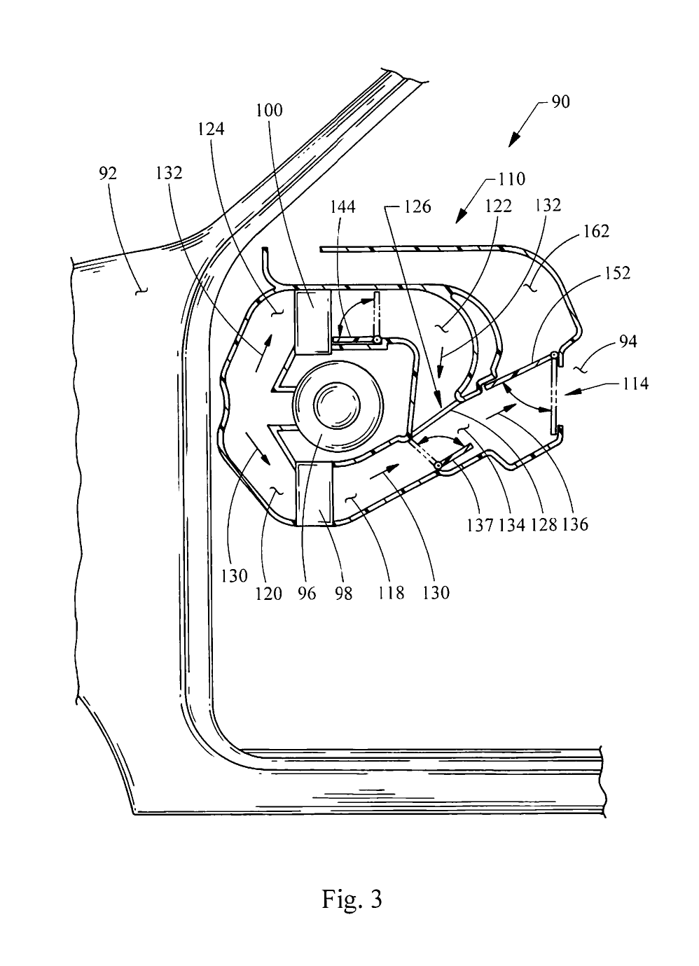

Referring now to the drawings, a case and duct assembly embodying the principles of the present invention is illustrated therein and designated at 10. As its primary components, the duct assembly 10 includes an outer wall 12 defining an interior volume, at least one ventilation port 14 and a plurality of interior walls 16 defining at least a first air passage 18 and a second air passage 22. The ventilation port 14 may, for example, open into a passenger compartment of a motor vehicle (see FIG. 3). The first air passage 18 extends from an input portion 20 to the ventilation port 14. The second air passage 22 extends from an input section 24 to an output aperture 26 intersecting the first air passage 18. Arranged across the output aperture 26 is a slotted wall 28.

In the embodiment shown, flowing air is provided and divided into at least a first air stream (indicated by the arrow 30) and a second air stream (indicated by the arrow 32). The first air stream 30 flows within the first air passage 18 from the input portion 20 downstream to the ventilation port 14. The second air stream 32 flows within the second air passage 22 from the input section 24 downstream to the output aperture 26.

As indicated above, the second air passage 22 intersects and merges with the first air passage 18 upstream of the ventilation port 14. This merging with the first air stream 30 occurs in a mixing zone 34 of the first air passage 18, adjacent the output aperture 26 after the second air stream 32 flows through the slotted wall 28. This forms a mixed airflow (indicated by the arrow 36).

The merging of the two air streams 30 and 32 in the mixing zone 34 results in significant NVH being generated within the duct assembly 10. One reason for the generation of NVH is the resulting pressure drop between the higher pressure second air stream 32 of the output aperture 26 and the lower pressure first air stream 30 of the mixing zone 34. A second reason for the generation of NVH is turbulent air flow within the duct assembly 10. Turbulent air flow can be particularly evident in, for example, the mixing zone 34 where the walls directing the air streams 30 and 32 impart disturbances into the flows. These disturbances can be amplified by the merging of the two already turbulent air streams 30 and 32, resulting in significant turbulence in the mixing zone 34, causing additional NVH.

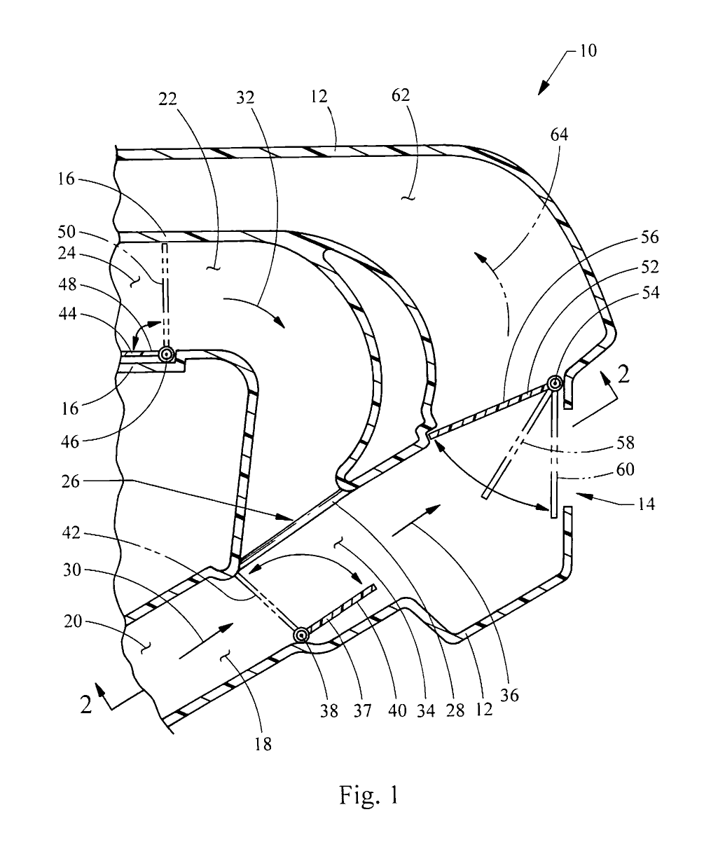

Also shown in the embodiment of FIG. 1 are a plurality of optional blend doors. Depending on the specific application, one or more of these blend doors may be necessary to control the air flow and air temperature within and exiting the duct assembly 10. More specifically, the first air passage 18 may include a first air blend door 37 located upstream of the mixing zone 34. In the example shown, the first blend door 37 is pivotable about a first axis 38 between a fully open position, shown by the solid lines 40, and a fully closed position, shown by the phantom lines 42. Thus, this door 37 regulates the flow of first air stream 30 into the mixing zone 34. Depending on the position of the first blend door 37, the amount of flow of the first air stream 30 entering the mixing zone 34 can be varied to control, for example, a temperature of the mixed airflow 36. It should be understood that the pivotable blend door 37 is but one embodiment of the optional blend doors. Any other appropriate door or orifice capable of controlling airflow may be used including for example, a butterfly door or a door that translates linearly rather than pivots about an axis.

Other embodiments of the case and duct assembly 10 may include a second air blend door 44 and/or a mixed air blend door 52. In the example shown, the second blend door 44 is disposed upstream of the output aperture 26. The second blend door 44 is pivotable about a second axis 46 between a fully open position, shown by the solid lines 48, and a fully closed position, shown by the phantom lines 50, to regulate the flow of the second air stream 32 into the mixing zone 34. The mixed blend door 52 is pivotable about a third axis 54 between a first orientation, shown by the solid lines 56, an intermediate orientation, shown by the phantom lines 58, and a third orientation, shown by the phantom lines 60, to regulate the flow of the mixed airflow 36 between the ventilation port 14 and at least one additional passage 62.

The additional passage 62 intersects the first air passage 18 between the ventilation port 14 and the mixing zone 34. When the mixed blend door 52 is in the first orientation 56, none or negligible amounts of the mixed airflow 36 is permitted to enter the additional passage 62. Conversely, when the mixed blend door 52 is in the third orientation 60 substantially all of the mixed airflow 36 enters the additional passage 62 as indicated by the arrow 64. In the intermediate position 56, a relative amount of the mixed airflow 36 enters both the additional passage 62 and the ventilation port 14. Consequently, the amount of air passing through the ventilation port 14 is regulated (i.e. increasing the amount of air entering the additional passage 62 decreases the amount of air flowing through the ventilation port 14). In some examples, the additional passage 62 may direct at least part of the mixed airflow 36 so as to defrost a windshield of the motor vehicle (see FIG. 3). In other examples (not shown), the additional passage 62 may direct the mixed airflow 36 to a floor of the motor vehicle.

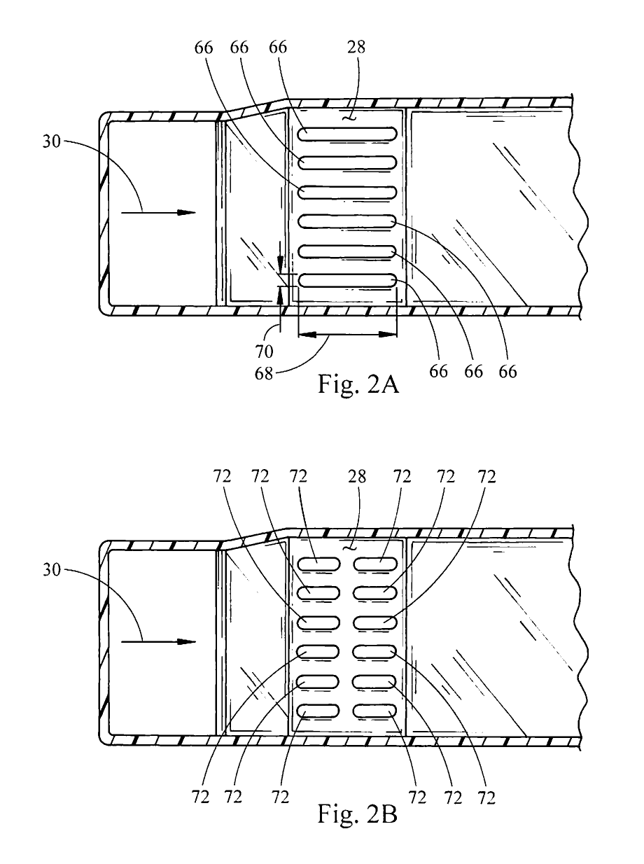

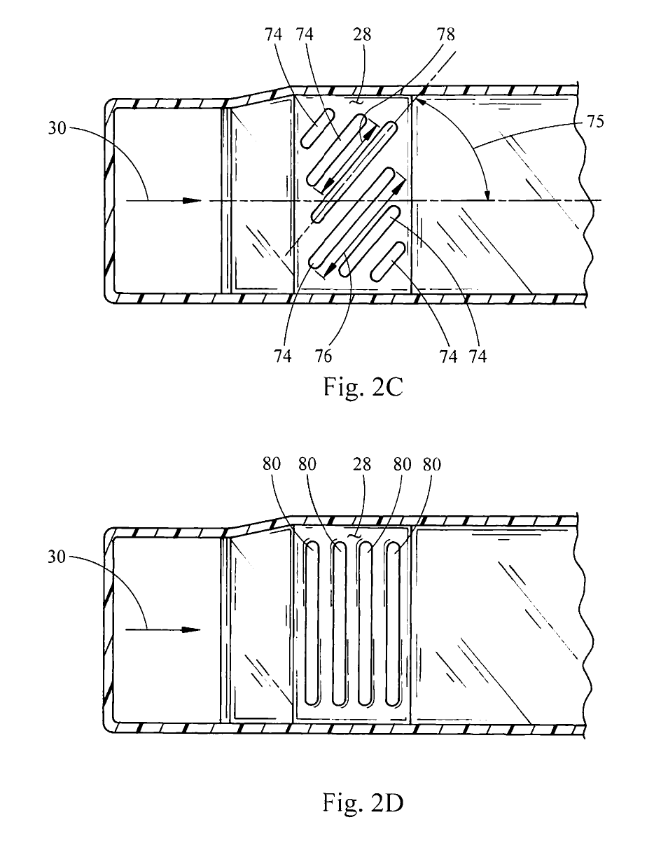

FIGS. 2A-2D are taken along line 2-2 of FIG. 1 and show various embodiments of the slotted wall 28. In one example, the slotted wall 28 may be formed from a flat or arcuate section of the interior walls 16. In another example, the slotted wall 28 may be formed from a flat plate across the output aperture 26.

Turning to FIG. 2A, a first embodiment of the slotted wall 28 includes a plurality of slots 66 having a length 68 and a width 70 with the length 68 being substantially greater than the width 70. In the example shown, the length 68 is approximately 7-8 times greater than the width and the slots 66 are oriented substantially parallel to the first air stream 30. This arrangement reduces the pressure drop between the output aperture 26 and the mixing zone 34 and reduces turbulence in the mixing zone 34, resulting in decreased NVH.

It should be understood that the above relative dimensions and orientation are but examples of a single embodiment. Different proportions are possible depending on the exact geometry, materials and other needs of a particular application.

A second embodiment shown in FIG. 2B illustrates multiple rows of slots 72 provided across the output aperture 26. A third embodiment shown in FIG. 2C provides angled slots 74. The angled slots 74 may be oriented at an acute angle 75 to the first air stream 30. This embodiment also illustrates that a length 76 of one slot 74 may be different from the length 78 of another slot 74. Finally, as best shown in FIG. 2D, it is also possible for slots 80 to be oriented substantially perpendicular to the first air stream 30.

Turning now to FIG. 3, an HVAC system 90 for use in a motor vehicle 92 is shown. In this embodiment, features having the same function as described above have the same number as used in the embodiment of FIG. 1, only indexed by 100. The HVAC system 90 includes a duct assembly 110 having an outer wall defining an interior volume and a plurality of interior walls defining at least a first air passage 118, at least a second air passage 122, and at least one additional passage 162.

The first air passage 118 extends from an input portion 120 to the ventilation port 114 that may, for example, open into a passenger compartment 94 of the motor vehicle 92. This permits a first air stream 130 to flow from the input portion 120 out through the ventilation port 114 and into the passenger compartment 94. The second air passage 122 extends from an input section 124 to an output aperture 126 that intersects the first air passage 118, generally upstream of the ventilation port 114. This permits a second air stream 132 to merge with the first air stream 130 at a mixing area 134. A slotted wall 128 is arranged across the output aperture 126. This slotted wall 128 may have any of the configurations described above and illustrated in FIGS. 2A-2D.

Additionally, the HVAC system 90 includes at least one blower 96 fluidly coupled to the duct assembly 110 and providing airflow within the duct assembly 110. The airflow is divided within the duct assembly by any appropriate means into the first air stream 130 and the second air stream 132. The HVAC system 90 further includes a cooling unit 98 and a heating unit 100, respectively disposed within the input portions 120 and 124 of the first and second air passages 118 and 122.

The cooling unit 98 may be any conventional unit configured to cool the first air stream 130. The cooling unit 98 may include, for example, an evaporator fluidly coupled to other components of an air conditioning system (not shown) of the motor vehicle 92, or thermoelectric devices powered by an electrical system (not shown) of the motor vehicle 92. Likewise, the heating unit 100 may be any conventional unit configured to heat the first air stream 132. The heating unit 100 may include, for example, a heater core fluidly coupled to other components of an engine cooling system (not shown) of the motor vehicle 92, or electric heaters powered the electrical system. Obviously, the units 98 and 100 could be reversed in their locations.

Consequently, a cooled first air stream 130 and a heated second air stream 132 are mixed within the mixing zone 134 in the first air passage 118, forming a mixed air flow 136. The mixed air flow 136 may have any appropriate temperature and flow distribution necessary for a particular set of conditions. The necessary temperature and flow distribution may be provided by adjusting one or more blend air doors 137, 144, and 152, as analogously described above.

As a person skilled in the art will readily appreciate, the above description is meant as an illustration of implementation of the principles this invention. This description is not intended to limit the scope or application of this invention in that the invention is susceptible to modification, variation and change, without departing from spirit of this invention, as defined in the following claims.

I claim:

1. A case and duct assembly for a heating, ventilation, and air conditioning system having passive noise reduction, the duct assembly comprising:
an outer wall defining an interior volume, interior walls being disposed within the interior volume and defining at least a first air passage and a second air passage;
the first air passage extending from an input portion to a ventilation port such that a first air stream may flow downstream from the input portion to the ventilation port;
the second air passage extending from an input section to an output aperture, the output aperture intersecting the first air passage upstream of the ventilation port such that a second air stream may flow from the input section to the output aperture and into the first air passage thereby defining a mixing zone adjacent the output aperture and forming a mixed airflow; and
a slotted wall being arranged across the output aperture.

2. The duct assembly of claim 1 wherein the duct assembly further includes at least one air blend door located upstream of the mixing zone, the air blend door being located in one of the first and second air passages and being pivotable between a fully open and a fully closed position to regulate the mixing zone and control the mixed airflow.

3. The duct assembly of claim 1 further including at least one additional passage wherein the additional passage intersects the first air passage between the ventilation port and the mixing zone.

4. The duct assembly of claim 3 wherein the duct assembly further includes at least one mixed air blend door located upstream of the ventilation port, the mixed air blend door being pivotable between first and second positions and arranged to regulate the amount of the mixed airflow entering the additional passage and exiting through the ventilation port, in the first position the mixed air blend door obstructing the additional passage and in the second position the mixed air blend door obstructing the ventilation port.

5. The duct assembly of claim 1 wherein the slotted wall includes a plurality of slots extending across a majority of the output aperture, the slots having a length and a width with the length being greater than the width.

6. The duct assembly of claim 5 wherein the length is substantially greater than the width.

7. The duct assembly of claim 5 wherein the slots are oriented substantially parallel with the first air stream.

8. The duct assembly of claim 5 wherein the slots are oriented substantially perpendicular to the first air stream.

9. The duct assembly of claim 5 wherein the slots are oriented at an acute angle relative to the first air stream.

10. The duct assembly of claim 5 wherein the slots are provided in at least two rows across the output aperture.

11. The duct assembly of claim 1 wherein the slotted wall is formed in a flat plate.

12. A heating, ventilation, and air conditioning system having passive noise reduction for use in a motor vehicle, the system comprising:
a duct assembly having an outer wall defining an interior volume, interior walls being disposed within the interior volume and defining at least a first air passage, a second air passage, and at least one additional passage;
the first air passage extending from an input portion to a ventilation port opening into a passenger compartment of the motor vehicle such that a first air stream may flow downstream from the input portion through the ventilation port and into the passenger compartment;
the second air passage extending from an input section extending to an output aperture, the output aperture intersecting the first air passage upstream of the ventilation port such that a second air stream may flow from the input section to the output aperture and into the first air passage thereby defining a mixing zone adjacent the output aperture and forming a mixed airflow;
a slotted wall being arranged across the output aperture;
the at least one additional passage having an upstream segment intersecting the first air passage downstream of the output aperture;
at least one blower fluidly coupled to the duct assembly and providing airflow therein, the airflow being divided into the first air stream and the second air stream; and
a cooling unit being disposed in the first air stream thereby cooling the first air stream and a heating unit being disposed in the second air stream thereby heating the second air stream.

13. The system of claim 12 wherein the duct assembly further includes at least one air blend door upstream of the mixing zone and at least one mixed air blend door upstream of the ventilation port;
the air blend door being located in one of the first and second air passages and being pivotable between a fully open and a fully closed position to regulate the mixing zone and control the mixed airflow;
the mixed air blend door being pivotable between at least two orientations and arranged to regulate the amount of the mixed temperature airflow entering the additional passage and exiting through the ventilation port, in the first position the mixed air blend door obstructing the additional passage and in the second position the mixed air blend door obstructing the ventilation port.

14. The system of claim 12 wherein the slotted wall includes a plurality of slots extending across a majority of the output aperture, the slots having a length and a width with the length being substantially greater than the width.

15. The system of claim 14 wherein the length is substantially greater than the width.

16. The system of claim 14 wherein the slots are oriented substantially parallel with a direction of the first air stream.

17. The system of claim 14 wherein the slots are oriented substantially perpendicular to a direction of the first air stream.

18. The system of claim 14 wherein the slots are oriented at an acute angle to a direction of the first air stream.

19. The system of claim 14 wherein the slots are provided in at least two rows across the output aperture.

20. The system of claim 12 wherein the slotted wall is formed in a flat plate.
